(19) United States
(12) Patent Application Publication
(10) Pub. No.: US 2026/0279891 A1
(43) Pub. Date: Sep. 17, 2026

(54) POLYMERIZED, CROSSLINKED ELECTROLYTE FOR AN ELECTROCHEMICAL CELL

(71) Applicant: UT-Battelle, LLC, Oak Ridge, TN (US)

(72) Inventors: Md Anisur Rahman, Knoxville, TN (US); Catalin Gainaru, Lenoir City, TN (US); Alexei P. Sokolov, Oak Ridge, TN (US)

(21) Appl. No.: 19/563,665

(22) Filed: Mar. 11, 2026

Related U.S. Application Data
(60) Provisional application No. 63/771,122, filed on Mar. 13, 2025.

(51) Int. Cl. H01M 10/056; C08F 234/02; C08K 5/43; H01M 10/052; H01M 10/054

(52) U.S. Cl. CPC H01M 10/056; C08F 234/02; C08K 5/43; H01M 10/052; H01M 10/054; C08F 2810/20; H01M 2300/0065; H01M 2300/0091

(57) ABSTRACT

A method of making an alkali polymer electrolyte in-situ is provided. The method includes combining at least one monomer component, an alkali-containing salt, a crosslinker, and an initiator to obtain a precursor mixture. The method further includes applying energy to the precursor mixture to form a crosslinked polymer. The step of applying energy is performed in-situ in an electrochemical cell, and the crosslinked polymer is formed directly on an electrode in the electrochemical cell. The alkali may be lithium or sodium. The at least one monomer component may include an acrylate-(trifluoromethane)sulfonimide compound, an acrylate-(fluorosulfonyl)imide compound, a methacrylate-(trifluoromethane)sulfonimide compound, a methacrylate-(fluorosulfonyl)imide compound, a vinyl-(trifluoromethane)sulfonimide compound, a vinyl-(fluorosulfonyl)imide compound, a vinyl compound, a styrene-(trifluoromethane)sulfonimide compound, and/or a styrene-(fluorosulfonyl)imide compound. The crosslinker may be a diacrylate compound, triacrylate compound, or tetraacrylate compound. The energy may be in the form of heat or ultraviolet (UV) radiation.

### CROSS-REFERENCE TO RELATED APPLICATIONS

This application claims the benefit of U.S. Provisional Application No. 63/771,122, filed Mar. 13, 2025, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a method of making polymer electrolytes for battery applications.

### BACKGROUND OF THE INVENTION

Rising demand for safe, high-energy density electricity storage in household appliances, mobile electronics and electric vehicles has increased the need to overcome the current limitations of liquid electrolyte-based batteries. As an alternative to liquid electrolytes, most ceramic electrolytes, despite their high Li⁺/Na⁺ conductivities and large mechanical stiffnesses, suffer from electrochemical instability, poor electrode contact, inability to suppress dendrite formation, and deficient large-area manufacturing. Also, while polymer electrolytes such as salt-doped poly(ethylene oxide) (PEO) and their ceramic composites provide a good alternative in terms of mechanical flexibility, electrode adhesion, and processability, they often display relatively low room temperature conductivity and limited electrochemical window.

Single-ion conducting polymers (SICPs) may overcome many technological drawbacks of ceramics and salt-doped polymers by combining the high charge density of ionic liquids with the safety and operational stability of nonfluid electrolytes. In most SICPs, all the anions are covalently attached to the polymer chains, generating a negatively charged, solid-like matrix in which the cations (e.g., Li⁺/Na⁺) can perform long-range diffusion. With the anion species effectively immobilized, the SICPs are characterized by large cation transport numbers that are greater than that of salt-doped polymer electrolytes. A high transport number is critical for battery performance because it can reduce polarization, enabling high charge/discharge rates. Also, attaching the anions to chains is beneficial for achieving a homogeneous distribution of charge carriers at the electrodes.

Despite these many advantages, the deployment of bulk SICPs for battery applications is hampered by their relatively low conductivity near ambient temperature and by their faulty (solid-solid) adhesion to the porous cathode material. Therefore, a need continues to exist for improved electrolytes for battery applications.

### SUMMARY OF THE INVENTION

A method of making an alkali polymer electrolyte in-situ is provided. The method includes combining at least one monomer component, an alkali-containing salt, a crosslinker, and an initiator to obtain a precursor mixture. The method further includes applying energy to the precursor mixture to form a crosslinked polymer. The step of applying energy is performed in-situ in an electrochemical cell, and the crosslinked polymer is formed directly on an electrode in the electrochemical cell.

In specific embodiments, the alkali is selected from a group of lithium and sodium.

In specific embodiments, the energy is in the form of heat or ultraviolet (UV) radiation.

In specific embodiments, the at least one monomer component includes one or more of an acrylate-(trifluoromethane)sulfonimide (ATFSI) compound, an acrylate-(fluorosulfonyl)imide (AFSI) compound, a methacrylate-(trifluoromethane)sulfonimide (MTFSI) compound, a methacrylate-(fluorosulfonyl)imide (MFSI) compound, a vinyl-(trifluoromethane)sulfonimide (VTFSI) compound, a vinyl-(fluorosulfonyl)imide (VFSI) compound, a vinyl compound, a styrene-(trifluoromethane)sulfonimide (STFSI) compound, and a styrene-(fluorosulfonyl)imide (SFSI) compound.

In specific embodiments, the at least one monomer component includes lithium 1-[3-(methacryloyloxy)propylsulfonyl]-1-(trifluoromethylsulfonyl) imide or sodium 1-[3-(methacryloyloxy)propylsulfonyl]-1-(trifluoromethylsulfonyl) imide.

In specific embodiments, the alkali-containing salt is lithium bis(trifluoromethanesulfonyl)imide (LiTFSI), sodium bis(trifluoromethanesulfonyl)imide (NaTFSI), lithium bis(fluorosulfonyl)imide (LiFSI), or sodium bis(fluorosulfonyl)imide (NaFSI).

In specific embodiments, the crosslinker is a diacrylate compound, a triacrylate compound, or a tetraacrylate compound.

In specific embodiments, the crosslinker is trimethylolpropane triacrylate.

In specific embodiments, the initiator is a thermal initiator is azodiisobutyronitrile.

In specific embodiments, the initiator is a photo initiator that is 2-hydroxy-2 -methylpropiophenone.

In specific embodiments, the at least one monomer component includes: i) a vinyl-containing compound; and ii) an alkali-TFSI-containing compound; and the alkali-containing salt is an alkali-TFSI salt.

In particular embodiments, a molar ratio of the vinyl-containing compound to the alkali-TFSI-containing compound to the alkali-TFSI salt is approximately x:1:1, wherein x is in a range of from 1 to 20.

In specific embodiments, the step of combining at least one monomer component, an alkali-containing salt, a crosslinker, and an initiator to obtain a precursor mixture includes: i) mixing the at least one monomer component and the alkali-containing salt to form a first mixture; ii) adding the crosslinker to the first mixture and mixing to form a second mixture; and iii) adding the initiator to the second mixture and mixing to form the precursor mixture.

In specific embodiments, the method further includes: i) soaking a separator with the precursor mixture; ii) sandwiching the soaked separator between an anode and a cathode to form a stack; iii) sealing the stack in the electrochemical cell; and iv) applying energy to the electrochemical cell for a period of time, wherein the energy is in the form of heat or ultraviolet (UV) radiation.

In specific embodiments, the method further includes: i) disposing the precursor mixture between an anode and a cathode in the electrochemical cell; and ii) applying energy to the electrochemical cell for a period of time, wherein the energy is in the form of heat or ultraviolet (UV) radiation.

In specific embodiments, the method further includes: i) disposing the precursor mixture on top of an electrode; and ii) applying energy to the electrode for a period of time, wherein the energy is in the form of heat or ultraviolet (UV) radiation.

In specific embodiments, the period of time is at least 1 hour.

A polymer electrolyte for an electrochemical cell is also provided. The polymer electrolyte includes a cation. The polymer electrolyte also includes a crosslinked copolymer. The crosslinked polymer has a chemical structure including: i) at least one monomer unit, each monomer unit selected from a group of an acrylate-TFSI compound, an acrylate-FSI compound, a methacrylate-TFSI compound, a methacrylate-FSI compound, a vinyl-TFSI compound, a vinyl-FSI compound, a vinyl compound, a styrene-TFSI compound, and a styrene-FSI compound; and ii) a crosslinker unit that is selected from a group of a diacrylate compound, triacrylate compound, or tetraacrylate compound.

In specific embodiments, the cation is Li⁺ or Na⁺.

An electrochemical cell is also provided. The electrochemical cell includes an electrode and the polymer electrolyte according to any of the embodiments above, formed directly on the electrode.

These and other features of the invention will be more fully understood and appreciated by reference to the description of the embodiments and the drawings.

### BRIEF DESCRIPTION OF THE DRAWINGS

FIG. 1 is a schematic illustration of a method of making an alkali polymer electrolyte in-situ according to embodiments of the disclosure;

FIG. 2 is a diagram of a chemical synthesis to form a crosslinked Li-polyelectrolyte via free radical crosslinking in accordance with embodiments of the disclosure;

FIG. 3 is a diagram of a chemical synthesis to form a crosslinked Na-polyelectrolyte via free radical crosslinking in accordance with embodiments of the disclosure;

FIG. 4 is a graph of the time evolution of conductivity response during the polymerization/crosslinking at 80° C. in accordance with embodiments of the disclosure;

FIG. 5 is a graph of direct-current (DC) conductivities of lithium and sodium copolymers with salt in accordance with embodiments of the disclosure, lithium and sodium copolymers without salt, and lithium and sodium homopolymers without salt;

FIG. 6 is a graph of room-temperature conductivity of in-situ polymerized and crosslinked electrolytes in accordance with embodiments of the disclosure, in an electrochemical cell with a Celgard separator, an electrochemical cell with a polyacrylonitrile (PAN) separator, and an electrochemical cell without a separator;

FIG. 7 is a graph of Nyquist plots before and after polarization of an electrochemical cell including a Li-based crosslinked polymer electrolyte made in accordance with embodiments of the disclosure;

FIG. 8 is a graph of cyclic voltammetry (CV) at 30° C. of an electrochemical cell including a Li-based crosslinked polymer electrolyte made in accordance with embodiments of the disclosure; and

FIG. 9 is a graph of discharge capacities and coulombic efficiencies at 30° C. and C/10 rate for i) an electrochemical cell including a lithium iron phosphate (LFP) cathode, a Li metal anode, a PAN separator, and a Li-based crosslinked polymer electrolyte made in accordance with embodiments of the disclosure; ii) an electrochemical cell including an NMC622 cathode, a Li metal anode, a Celgard separator, and a Li-based crosslinked polymer electrolyte made in accordance with embodiments of the disclosure; and iii) an electrochemical cell including an NMC622 cathode, a Li metal anode, a Celgard separator, and a conventional non-crosslinked polymer electrolyte.

### DETAILED DESCRIPTION OF THE CURRENT EMBODIMENTS

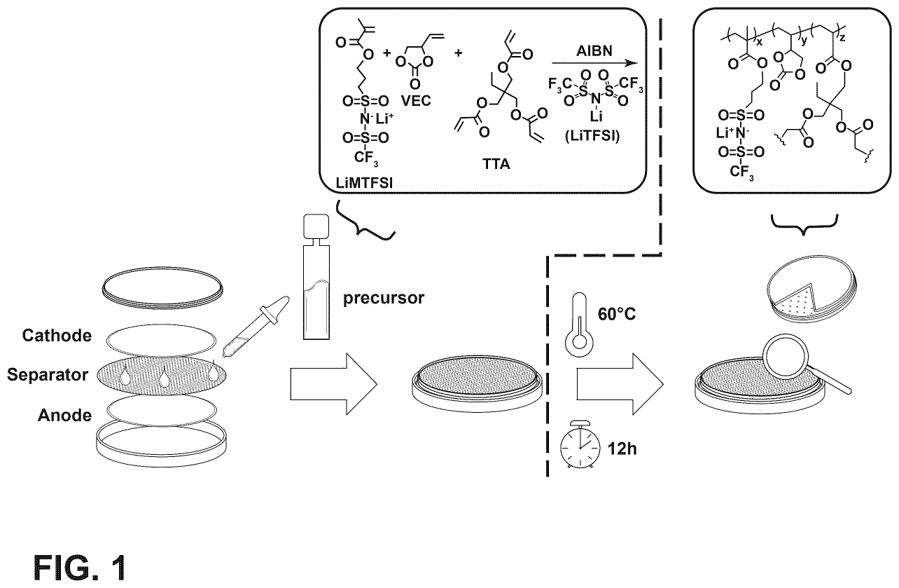

As discussed herein, the current embodiments relate to a method for in-situ manufacturing of an alkali polymer electrolyte. As generally illustrated in FIG. 1, the method includes combining reaction components to form a precursor mixture, disposing the precursor mixture within an electrochemical cell, and applying energy to form a crosslinked polymer within the cell and directly on an electrode of the cell. The method may reduce polymerization time up to a factor of three without compromising the conductivity of the electrolier. The obtained polymerized and crosslinked copolymer electrolytes also provide for stable cycling up to 1 mA/cm² and compatibility with high-voltage type cathodes. Additionally, the present method may be extended beyond lithium electrolytes for lithium battery cells, for example, to sodium electrolytes.

The method first includes combining the reaction components to obtain the precursor mixture. The reaction components generally include at least one monomer component, an alkali-containing salt, a crosslinker, and an initiator. No solvent need be included in the precursor mixture. In some embodiments, the one or more monomer components are first mixed with the alkali-containing salt to form a first mixture. Subsequently, the crosslinker is added to the first mixture to form a second mixture, and the initiator is added to the second mixture to form the precursor mixture. However, it should be understood that the crosslinker could be mixed together with the monomer component(s) and alkali-containing salt at one time, or that all components could be mixed together at once.

In various embodiment, the monomer component is one or more component chosen from the group of an acrylate-(trifluoromethane)sulfonimide (acrylate-TFSI; ATFSI) compound, an acrylate-(fluorosulfonyl)imide (acrylate-FSI; AFSI) compound, a methacrylate-(trifluoromethane)sulfonimide (methacrylate-TFSI; MTFSI) compound, a methacrylate-(fluorosulfonyl)imide (methacrylate-FSI; MFSI) compound, a vinyl-(trifluoromethane)sulfonimide (vinyl-TFSI; VTFSI) compound, a vinyl-(fluorosulfonyl)imide (vinyl-FSI; VFSI) compound, a vinyl compound, a styrene-(trifluoromethane)sulfonimide (styrene-TFSI; STFSI) compound, and a styrene-(fluorosulfonyl)imide (styrene-FSI; SFSI) compound. One or more of the monomer component compounds may also include an alkali such as lithium (Li) or sodium (Na). In these embodiments, the alkali is a cation, and the anion is either deprotonated (trifluoromethane)sulfonimide (TFSI⁻) or deprotonated (fluorosulfonyl)imide (FSI⁻). In specific embodiments, one of the monomer components is an alkali methacrylate-TFSI such as lithium 1-[3-(methacryloyloxy)propylsulfonyl]-1-(trifluoromethylsulfonyl) imide (LiMTFSI) or sodium 1-[3-(methacryloyloxy)propylsulfonyl]-1-(trifluoromethylsulfonyl) imide (NaMTFSI). In specific embodiments, one of the monomer components is also a vinyl compound such as vinyl ethylene carbonate (VEC).

In various embodiments, the alkali-containing salt is a lithium or sodium salt such as lithium bis(trifluoromethanesulfonyl)imide (LiTFSI), lithium bis(fluorosulfonyl)imide (LiFSI), sodium bis(trifluoromethanesulfonyl)imide (NaTFSI), or sodium bis(fluorosulfonyl)imide (NaFSI).

In some embodiments, the monomer components include a vinyl-containing compound (such as, for example, VEC) and an alkali-TFSI-containing compound (such as, for example, LiMTFSI). Further, the alkali-containing salt may be an alkali-TFSI salt (such as, for example, LiTFSI). The amount of an alkali-TFSI-containing monomer compound and alkali-containing salt in the mixture should be generally equal. Further, the molar ratio of the vinyl-containing compound to either or both of the alkali-TFSI-containing monomer compound and/or the alkali-containing salt may be in the range of 1:1 to 20:1, optionally 5:1 to 15:1, optionally 1:1 to 10:1, optionally 10:1 to 20:1, optionally 9:1 to 11:1, optionally 10:1. As such, the molar ratio of the vinyl-containing compound to the alkali-TFSI-containing monomer compound to the alkali-TFSI salt may be expressed as approximately x:1:1, wherein x is in a range of from approximately 1 to 20.

In various embodiments, the crosslinker is a diacrylate compound, a triacrylate compound, or a tetraacrylate compound. In specific embodiments, the crosslinker is trimethylolpropane triacrylate (TTA).

The initiator may be a thermal initiator or a photo initiator. In exemplary embodiments, the thermal initiator is azodiisobutyronitrile (AIBN). In other exemplary embodiments, the photo initiator is 2-hydroxy-2-methylpropiophenone.

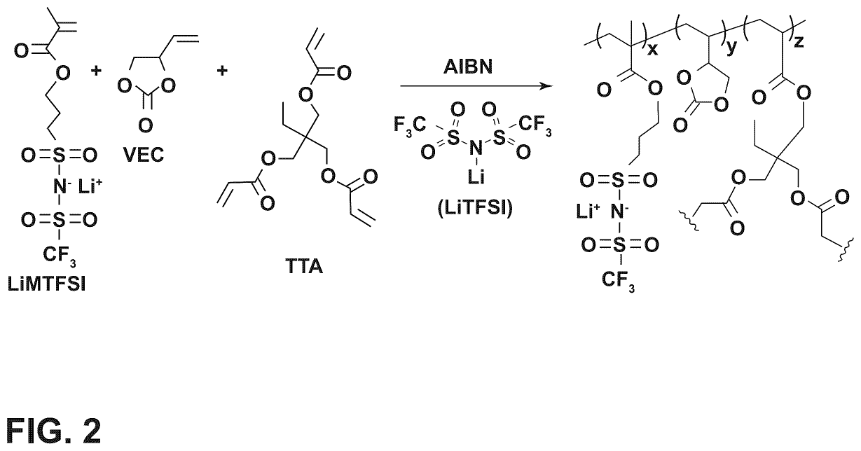

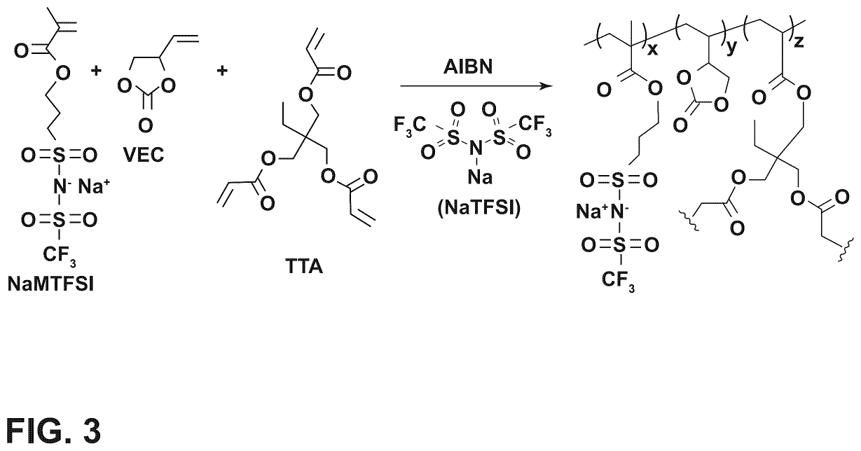

The method further includes applying energy to the precursor mixture to polymerize the monomer components and to form a crosslinked polymer. Particularly, the application of energy is performed in-situ with the precursor mixture in an electrochemical cell, i.e. energy is applied after the precursor mixture has been introduced into the electrochemical cell such as a battery cell. The precursor mixture also may be placed in direct contact with an electrode in the electrochemical cell. The obtained crosslinked polymer is formed directly on an electrode in the electrochemical cell, such as directly on the cathode and/or anode of the electrochemical cell. The energy is applied for a period of time, which may be at least 1 hour, optionally at least 2 hours, optionally at least 3 hours, optionally at least 4 hours, optionally at least 5 hours, optionally at least 6 hours, optionally at least 7 hours, optionally at least 8 hours, optionally at least 9 hours, optionally at least 10 hours, optionally between 1 and 12 hours, optionally between 2 and 4 hours, optionally between 4 and 6 hours, optionally between 8 and 10 hours. In some embodiments, the energy is in the form of heat, and the initiator is a thermal initiator that initiates radical polymerization upon heating. The application of heat generally raises the temperature of the reaction mixture above room temperature, i.e., above approximately 20° C., and typically no higher than 100° C. Therefore, the reaction temperature may be in a range of from 20 to 100° C., optionally 25 to 100° C., optionally 60 to 100° C., optionally 20 to 80° C., optionally 50 to 80° C. In other embodiments, the energy is in the form of ultraviolet (UV) radiation, and the initiator is a photo initiator that initiates radical polymerization upon irradiation with UV light. Exemplary chemical reactions in accordance with embodiments of the method are shown by way of example only in FIGS. 2 and 3. In the obtained crosslinked copolymer electrolytes, x, y, and z are integers having a value of 1 or more and represent the number of the respective units included in the crosslinked copolymer.

In some embodiments, the method specifically includes soaking a separator with the precursor mixture, sandwiching the soaked separator between an anode and a cathode to form a stack, sealing the stack in the electrochemical cell, and then applying energy to the electrochemical cell for a period of time to form the crosslinked polymer electrolyte in-situ and in direct contact with (directly on) the anode and cathode. In other embodiments, no separator is used, and the method specifically includes disposing the precursor mixture between an anode and a cathode in the electrochemical cell, and then applying energy to the electrochemical cell for a period of time to form the crosslinked polymer electrolyte in-situ and in direct contact with the anode and cathode. For example, the anode may be placed in the electrochemical cell, the precursor mixture may be introduced into the cell on the anode, the cathode may be placed on top of the anode with the precursor mixture therebetween, and the electrochemical cell may be sealed, at which time energy may be applied to initiate the polymerization and crosslinking. In yet other embodiments, such as the formation of half-cells, the method specifically includes disposing the precursor mixture on top of an electrode, and then applying energy to the electrode for a period of time to form the crosslinked polymer electrolyte in-situ and in direct contact with the electrode.

The method thereby provides for the formation of (quasi) solid-state batteries (SSBs) with the simple step of applying energy to the electrochemical cell to polymerize the mixture of monomer(s), salt, crosslinker, and initiator in-situ. Non-polymerized monomers remain well-trapped in the formed crosslinked gel and do not leak. The obtained polymer electrolyte includes a cation such as a lithium cation or a sodium cation, and a crosslinked polymer having a chemical structure including the at least one monomer unit selected from an acrylate-TFSI compound, an acrylate-FSI compound, a methacrylate-TFSI compound, a methacrylate-FSI compound, a vinyl-TFSI compound, a vinyl-FSI compound, a vinyl compound, a styrene-TFSI compound, and a styrene-FSI compound, and a crosslinker unit selected from a diacrylate compound, triacrylate compound, or tetraacrylate compound. The polymer electrolyte is formed directly on the electrode in the electrochemical cell.

The doped quasi single-ion conducting copolymers obtained by the method are polymerized and crosslinked in-situ and enable one or more of: (i) good adhesion with the electrodes, mitigating delamination and interfacial resistances; (ii) homogeneous distribution of charge carriers near the electrode surfaces to prevent dendrite formation; (iii) interchangeable Li and Na (or other cation) transport using simple chemistry procedures, in contrast to superionic ceramics where switching cations is obstructed by structural stability; (iv) relatively large Li and Na conductivities (~0.1 mS/cm at ambient conditions) and decent transport number (~0.5) which dampens polarization effects; and (v) mechanical robustness, with safety benefits in preventing electrolyte spilling upon battery damage. Additionally, the method disclosed herein is easy to implement with current battery technologies and provides a viable route for the design of high energy density safe polymer-based batteries capable of long duty cycles, in line with current global demands for energy storage.

### EXAMPLES

The present method is further described in connection with the following laboratory examples, which are intended to be non-limiting.

Vinyl ethylene carbonate (VEC: 2 g, 17.5 mmol), lithium 1-[3-(methacryloyloxy)propylsulfonyl]-1-(trifluoromethylsulfonyl)imide (LiMTFSI: ~0.604 g, 1.75 mmol), and lithium bis(trifluoromethanesulfonyl)imide (LiTFSI: 0.5 g) were placed in a glass bottle and stirred for 30 minutes to form a homogeneous solution. A crosslinker, trimethylolpropane triacrylate (TTA: 0.047 g, 0.16 mmol), was added to the solution. Azodiisobutyronitrile (AIBN: 28 mg, 0.171 mmol) was then added as an initiator, and the mixture was stirred for approximately 30 minutes, yielding a clear precursor solution. The resulting precursor solution was polymerized under an inert atmosphere at 75° C. for 2 to 3 hours, forming a gel-type crosslinked Li-electrolyte as shown in FIG. 2.

Similarly, VEC (2 g, 17.5 mmol), sodium 1-[3-(methacryloyloxy)propylsulfonyl]-1-(trifluoromethylsulfonyl)imide (NaMTFSI: ~0.634 g, 1.75 mmol), and sodium bis(trifluoromethanesulfonyl)imide (NaTFSI: 0.532 g, 1.75 mmol) were placed in a glass bottle and stirred for 30 minutes to form a homogeneous solution. The crosslinker TTA (0.047 g, 0.16 mmol) was added to the solution. AIBN (28 mg, 0.171 mmol) was then added as an initiator, and the mixture was stirred for approximately 30 minutes, yielding a clear precursor solution. The resulting precursor solution was polymerized under an inert atmosphere at 75° C. for 2 to 3 hours, forming a gel-type crosslinked Na-electrolyte as shown in FIG. 3.

A non-crosslinked polymer electrolyte (poly(VEC-r-LiMTFSI) was made as a comparative example by placing VEC (2 g, 17.5 mmol), LiMTFSI (~0.604 g, 1.75 mmol), and LiTFSI (0.5 g) in a glass bottle and stirring for 30 minutes to form a homogeneous solution. AIBN (28 mg, 0.171 mmol) as the initiator was added to the solution and stirred for approximately 30 minutes, yielding a clear precursor solution. The resulting solution was polymerized under an inert atmosphere at 75° C. for 2 to 3 hours to form a gel-type polyelectrolyte.

These electrolyte products (after thermally-induced free radical polymerization/crosslinking) are random copolymers including MTFSI-and VEC monomers, which incorporate unpolymerized VEC fragments and mobile ions. According to proton NMR data, while all LiMTFSI monomers were fully polymerized, only 40% of the VEC monomers underwent polymerization. The remaining unreacted VEC monomers function as plasticizers, increasing the conductivity. The mechanism of conductivity in these gel-like electrolytes resembles that in liquid electrolytes: strongly coupled to structural relaxation of the matrix, i.e., similar to doped polyethylene oxide (PEO). However, due to the significant number of anions attached to the chain, the transport number is higher than in PEO electrolytes. The relative amount of freely migrating cations is controlled by the relative concentrations of MTFSI-present in the matrix and of the doping salt (LiTFSI or NaTFSI). Considering this morphological complexity, initial testing focused on the Li-based material for determining which [VEC]:[MTFSI−]:[LiTFSI] composition provides the highest conductivity near room temperature. To this end, temperature-dependent conductivity measurements were performed on several electrolytes with different relative concentrations of these three components. In-situ polymerization (at 80° C., overnight) of these samples was performed with and without crosslinkers directly in the probing capacitor. Based on these results, a [VEC]:[MTFSI⁻]:[LiTFSI] ratio of 100:10:10 molar composition was chosen for the battery tests due to its balanced high conductivity and mechanical strength. For facilitating comparison, the same ratio [VEC]:[MTFSI⁻]:[NaTFSI] of 100:10:10 was chosen for the Na electrolyte.

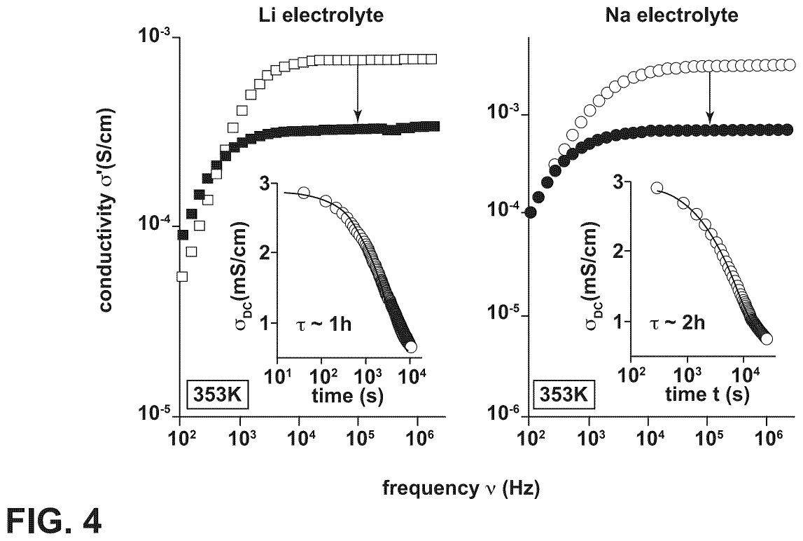

As shown in FIG. 4, the time evolution of several selected conductivity responses were recorded during the in-situ polymerization/crosslinking performed at 80° C. for the (100:10:10) Li and Na electrolytes. These spectra display at high frequencies the direct current (DC) conductivity plateaus with amplitudes σ_{DC}, while at low frequencies, they reflect polarization effects due to ion blocking at the electrodes. As indicated by the two arrows, the polymerization/crosslinking of the electrolytes triggers a progressive decrease of their DC conductivities below the 3×10⁻³ S/cm value corresponding to both precursors at 80° C. (the short-time σ₀ value in the insets). The solid lines of the insets represent curve fits using exponential decay functions. Particularly, to parameterize the time evolutions of σ_{DC}, interpolations of the data presented in the two insets was performed with exponential decay functions F(t)∝exp[−(t/τ)] providing the characteristic times τ of polymerization/crosslinking kinetics. These functions provided relatively good interpolation of experimental data with τ close to one hour for the Li system and two hours for the Na counterpart. These time constants are logistically relevant, since they can guide the optimization of polymerization/crosslinking inside the batteries. Based on these results, for the present methacrylate-based Li electrolyte, at 80° C. this process can be considered effectively completed after (4 to 5×τ) approximately four to five hours. However, the polymerization of methacrylate-based Na electrolytes may require eight to ten hours.

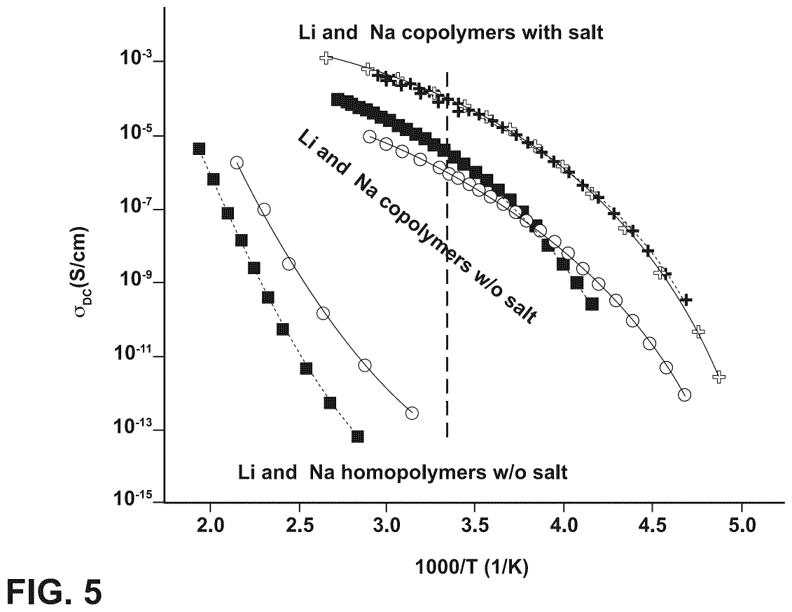

After the isothermal polymerization/crosslinking of the present two electrolytes, their frequency-dependent conductivity responses were probed over a temperature range from 80° C. down to −65° C. These spectra were used for extracting the DC conductivities plotted as a function of the inverse temperature in FIG. 5. The present electrolytes are denoted as “copolymers with salt.” Both the Li and Na polymer-based electrolytes displayed similar conductivities in their commonly investigated T range. Accordingly, replacing MTFSI-Li with MTFSI-Na monomers and LiTFSI with NaTFSI salt is not detrimental in terms of conductivity. These results demonstrate the versatility of the present electrolytes for enabling fast transport for different types of cations. As shown in the graph, the conductivity of the two doped copolymers near room temperature is about 0.1 mS/cm, which is quite high for mechanically robust electrolytes. To put these results in a broader perspective, the σDC results corresponding to the same copolymers without salt and for MTFSI-Li/MTFSI-Na homopolymers, with no VEC and no salt are also shown.

The homopolymer materials are the single-ion conducting polymers (SICPs) with the largest concentration of free Li⁺/Na⁺ ions. However, due to their high glass transition temperatures, their ambient conductivities are very low. With corresponding σ_{DC} below 10⁻¹³ S/cm near room temperature, these homopolymers have no practical relevance for battery applications. This changes when a large amount of mTFSI monomers are “replaced” with the VEC ones forming a copolymer without salt. As shown in FIG. 5, despite having a significantly lower number density of cations, these materials, which are still SICPs, display room-temperature σ_{DC} values close to 10⁻⁵ S/cm (for Li). Room temperature is signified by the vertical dashed line. The Li-containing materials are shown by solid, filled shapes, while the Na-containing materials are shown by open, non-filled shapes. This strong increase in conductivity occurs due to VEC acting both as a good plasticizer, strongly reducing the glass transition of the polymer, and as a highly polar group screening the Columbic interaction. To further increase σ_{DC} to about 10⁻⁴ S/cm, these copolymers are doped with a certain amount of salt, leading to the present electrolytes with both mechanical robustness and conductivity levels relevant for battery technologies. To quantify the conductivity changes induced by the salt addition, the temperature dependences of σ_{DC} of Na and Li copolymers included in FIG. 5 have been interpolated with Vogel-Fulcher-Tammann (VFT) functions σ_{DC}=σ_{DC,0}·exp[−D/(T−T₀)]. The data revealed that only copolymers with Li without salt have significantly higher T₀ and probably higher glass transition temperatures. Adding salt strongly increases conductivity essentially without change of T₀ in the case of Na-based copolymer.

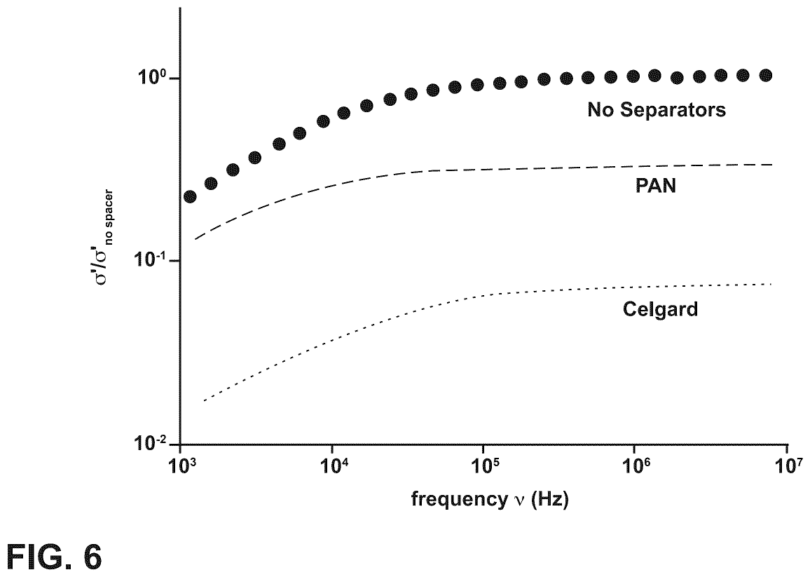

Before battery testing, the role of the separator for the effective conductivity of the electrolyte was also analyzed. Both a commercial Celgard separator traditionally used for liquid-electrolyte batteries and made of polypropylene (PP) and polyethylene (PE) and a laboratory-made PAN separator produced by electrospinning were utilized for testing. The separators were impregnated with the Li-based precursor electrolyte, and their corresponding room-temperature conductivity spectra are included in FIG. 6. These results reveal that Celgard reduces the conductivity of the electrolyte by about 15 times. Considering the nominal Celgard porosity of approximately 40%, the results demonstrate that this separator is poorly wetted by the present electrolyte. In contrast, as shown in the graph, the PAN separator reduces the conductivity by a factor of 3.

For battery testing, the electrolyte precursor and the AIBN initiator were mixed inside an Argon-filled glove box. The solution was cast onto cathodes, and CR2032 coin cells were assembled using lithium metal for the anode. Prior to testing, the cells were annealed at 60° C. overnight to allow polymerization and crosslinking of the electrolyte monomers. The electrochemical long-term cycling testing was performed at 30° C. on a Maccor battery cycler (series 4000) at a C/10 rate. The cutoff voltage was 2.5 and 4.2 V for the Lithium Iron Phosphate (LFP)-based cell and 3 and 4.2 V for NMC622-based cells. Electrochemical impedance spectra (EIS) were conducted on a BioLogic VSP3 potentiostat at an amplitude of 10 mV. The frequency range was from 1 MHz to 10 mHz. The EIS and cyclic voltammetry (CV) measurements were performed on a full-cell configuration with a lithium metal anode. The cathode formulation was based on 90 wt. % active material, 5 wt. % carbon black, and 5 wt. % polyvinylidene fluoride binder. The active material loading was 2.8 mg/cm² for the LFP-based cell and 2.19 mg/cm² for the NMC622-based cells. Plating/stripping at several current densities and transference number experiments were carried out on Li symmetric cells (12 mm in diameter). The transference number calculations were performed according to the Bruce-Vincent method by applying 5 mV for 2 h. The electrospun polyacrylonitrile (PAN) separator was approximately 30 μm thick.

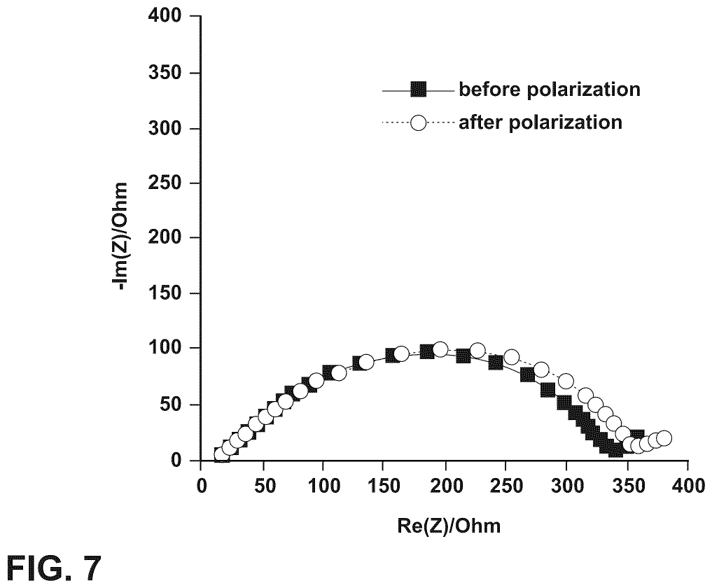

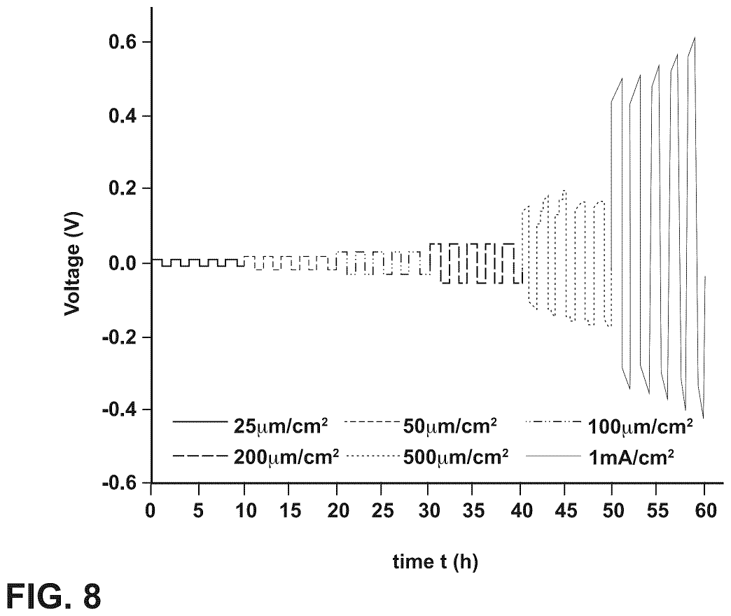

The lithium-based copolymer was initially tested in Li⁺/Li symmetric cells using a 25-micron thick Celgard separator. The corresponding Nyquist plots recorded before and after the polarization of such a cell used for the previously mentioned Bruce-Vincent tests are shown in FIG. 7. These plots revealed a relatively small overall impedance of the Li electrolyte-electrodes system, below 350, demonstrating the formation of a low impedance electrode-electrolyte interface (EEI) upon in-situ polymerization/crosslinking. These symmetric cells also displayed a stable voltage profile and low overpotential values of up to 1 mA/cm² current density as shown in FIG. 8.

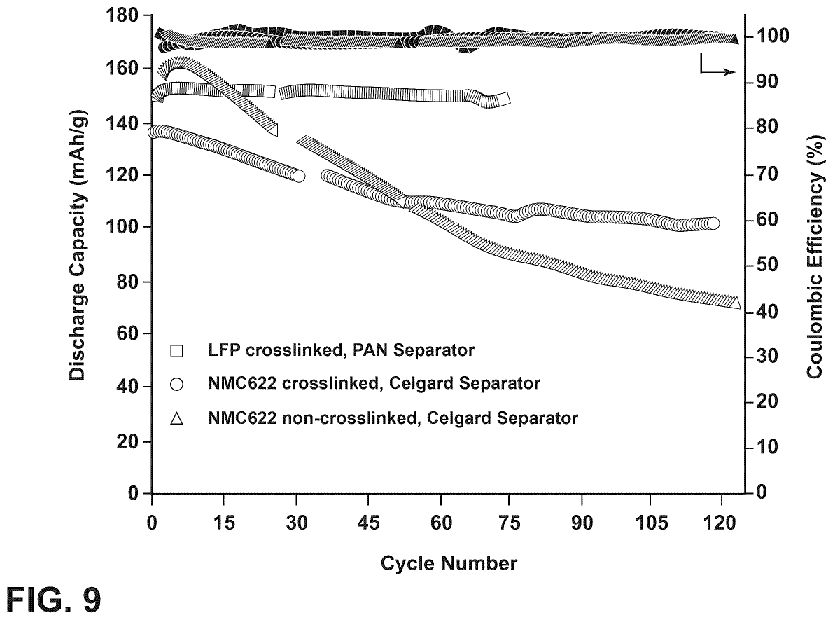

Long-term cycling of the lithium-based electrolyte was also performed at 30° C. in real batteries incorporating a high-voltage (4.2 V) NMC-622 cathode, the Celgard separator, and a lithium metal anode. The results shown in FIG. 9 demonstrate good capacity retention (approximately 79%) during charging and discharging for 80 cycles at C/10 rate. The capacity value after 117 cycles was 101 mAh/g. The Coulombic efficiency was almost 100% in the entire measurement range. The results also demonstrate that in-situ crosslinking has a beneficial role in better preserving the capacity of the NMC-based (Nickel Manganese Cobalt Oxide) batteries upon cycling. It is noted that these results were obtained using Celgard as a separator, which, as previously shown, is poorly wetted by the present electrolyte. Even better performance may be expected for other types of separators. Thus, the discharge capacity and Coulombic efficiency were also tested for a battery including a PAN separator and an LFP cathode (which was used simply to obtain preliminary results, whereas NMC cathodes may be more relevant to commercial uses). The measured capacity was approximately 150 mAh/g over the measured 70 cycles at C/10 rate and the Coulombic efficiency is 100%. This capacity value is very close to the practical capacity of the LFP (165 mAh/g) and this performance improvement may be attributed to a more porous PAN separator that results in better diffusion of the Li⁺ ions through the PAN separator. Further, the bulk resistance of the cell did not change. Furthermore, the C-rate capability of the non-crosslinked NMC622 cell showed that capacity fading becomes pronounced at C/3 and higher C-rates. Finally, the cyclic voltammetry (CV) measurement of the lithium electrolyte indicated that the lithium electrolyte is stable in the entire voltage range without showing any spurious reactions due to the electrochemical degradation.

The good performance of the present polymer electrolytes in both symmetric cells and NMC/LFP batteries may be attributed to homogenous charge distribution during cycling due to in-situ polymerization and crosslinking. As the precursor can penetrate the electrode pores, after the polymerization it forms a uniformly charged network which helps Li to distribute homogenously on the electrode. Also, no signs of dendrite formation were observed during these tests. Moreover, the observed transport numbers may reduce cell polarization and enhance battery life by avoiding over-potential issues.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of making an alkali polymer electrolyte in-situ, the method comprising:
combining at least one monomer component, an alkali-containing salt, a crosslinker, and an initiator to obtain a precursor mixture; and
applying energy to the precursor mixture to form a crosslinked polymer;
wherein the step of applying energy is performed in-situ in an electrochemical cell, and the crosslinked polymer is formed directly on an electrode in the electrochemical cell.

2. The method of claim 1, wherein the alkali is selected from a group of lithium and sodium.

3. The method of claim 1, wherein the energy is in the form of heat or ultraviolet (UV) radiation.

4. The method of claim 1, wherein the at least one monomer component includes one or more of an acrylate-(trifluoromethane)sulfonimide (ATFSI) compound, an acrylate-(fluorosulfonyl)imide (AFSI) compound, a methacrylate-(trifluoromethane)sulfonimide (MTFSI) compound, a methacrylate-(fluorosulfonyl)imide (MFSI) compound, a vinyl-(trifluoromethane)sulfonimide (VTFSI) compound, a vinyl-(fluorosulfonyl)imide (VFSI) compound, a vinyl compound, a styrene-(trifluoromethane)sulfonimide (STFSI) compound, and a styrene-(fluorosulfonyl)imide (SFSI) compound.

5. The method of claim 1, wherein the at least one monomer component includes lithium 1-[3-(methacryloyloxy)propylsulfonyl]-1-(trifluoromethylsulfonyl) imide or sodium 1-[3-(methacryloyloxy)propylsulfonyl]-1-(trifluoromethylsulfonyl) imide.

6. The method of claim 1, wherein the alkali-containing salt is lithium bis(trifluoromethanesulfonyl)imide (LiTFSI), sodium bis(trifluoromethanesulfonyl)imide (NaTFSI), lithium bis(fluorosulfonyl)imide (LiFSI), or sodium bis(fluorosulfonyl)imide (NaFSI).

7. The method of claim 1, wherein the crosslinker is a diacrylate compound, a triacrylate compound, or a tetraacrylate compound.

8. The method of claim 1, wherein the crosslinker is trimethylolpropane triacrylate.

9. The method of claim 1, wherein the initiator is a thermal initiator is azodiisobutyronitrile.

10. The method of claim 1, wherein the initiator is a photo initiator that is 2-hydroxy-2-methylpropiophenone.

11. The method of claim 1, wherein:
the at least one monomer component includes: i) a vinyl-containing compound; and ii) an alkali-TFSI-containing compound; and
the alkali-containing salt is an alkali-TFSI salt.

12. The method of claim 11, wherein a molar ratio of the vinyl-containing compound to the alkali-TFSI-containing compound to the alkali-TFSI salt is approximately x:1:1, wherein x is in a range of from 1 to 20.

13. The method of claim 1, wherein the step of combining at least one monomer component, an alkali-containing salt, a crosslinker, and an initiator to obtain a precursor mixture comprises:
mixing the at least one monomer component and the alkali-containing salt to form a first mixture;
adding the crosslinker to the first mixture and mixing to form a second mixture; and
adding the initiator to the second mixture and mixing to form the precursor mixture.

14. The method of claim 1, wherein the method further includes:
soaking a separator with the precursor mixture;
sandwiching the soaked separator between an anode and a cathode to form a stack;
sealing the stack in the electrochemical cell; and
applying energy to the electrochemical cell for a period of time, wherein the energy is in the form of heat or ultraviolet (UV) radiation.

15. The method of claim 1, wherein the method further includes:
disposing the precursor mixture between an anode and a cathode in the electrochemical cell;
applying energy to the electrochemical cell for a period of time, wherein the energy is in the form of heat or ultraviolet (UV) radiation.

16. The method of claim 1, wherein the method further includes:
disposing the precursor mixture on top of an electrode;
applying energy to the electrode for a period of time, wherein the energy is in the form of heat or ultraviolet (UV) radiation.

17. The method of claim 13, wherein the period of time is at least 1 hour.

18. The method of claim 14, wherein the period of time is at least 1 hour.

19. The method of claim 15, wherein the period of time is at least 1 hour.

20. A polymer electrolyte for an electrochemical cell, the polymer electrolyte comprising:
a cation; and
a crosslinked copolymer having a chemical structure including:
at least one monomer unit, each monomer unit selected from a group of an acrylate-TFSI compound, an acrylate-FSI compound, a methacrylate-TFSI compound, a methacrylate-FSI compound, a vinyl-TFSI compound, a vinyl-FSI compound, a vinyl compound, a styrene-TFSI compound, and a styrene-FSI compound;
a crosslinker unit that is selected from a group of a diacrylate compound, triacrylate compound, or tetraacrylate compound.

21. The polymer electrolyte of claim 20, wherein the cation is Li+ or Na+.

22. An electrochemical cell comprising:
an electrode; and
the polymer electrolyte of claim 20 formed directly on the electrode.
